(19) United States
(12) Patent Application Publication
(10) Pub. No.: US 2004/0042554 A1
(43) Pub. Date: Mar. 4, 2004

(54) Data encoding/decoding apparatus

(75) Inventors: Masanori Ishizuka, Kawasaki (JP); Masanori Kurita, Kawasaki (JP); Tatsushi Ohtsuka, Kawasaki (JP); Takahiko Tahira, Kawasaki (JP); Toshio Hosoi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/629,829

(22) Filed: Jul. 30, 2003

(30) Foreign Application Priority Data
Aug. 30, 2002 (JP) 2002-255920

(51) Int. Cl. H04N 7/12

(52) U.S. Cl. 375/240.26; 375/240.01

(57) ABSTRACT

A data encoding/decoding apparatus comprises a decoder which decodes a coded stream, which is formed in a first format and inputted on real time, to generate video data and audio data. A video output memory stores the video data from the decoder. An audio output memory stores the audio data from the decoder. A video input memory is provided to be connected to the decoder through a first data path when the coded stream is transcoded to generate a second stream formed in a second format. An audio input memory is provided to be connected to the decoder through a second data path when the transcoding is performed. An encoder encodes the video data from the video input memory and the audio data from the audio input memory to generate the second stream.

### CROSS-REFERENCE TO RELATED APPLICATIONS

This application is based upon and claims the benefit of priority from the prior Japanese patent application No. 2002-255920, filed on Aug. 30, 2002, the entire contents of which are incorporated herein by reference.

### BACKGROUND OF THE INVENTION

1. Field of the Invention

The present invention relates to a data encoding/decoding apparatus which is configured to perform the encoding of video and audio data into the stream in another form while performing the decoding of a coded stream (digital data) which is inputted on real time, into the reconstructed video and audio signals.

2. Description of the Related Art

FIG. 1 shows the composition of a conventional data encoding/decoding apparatus. With reference to FIG. 1, a description will be given of operation of the conventional data encoding/decoding apparatus when the encoding of video and audio data and the decoding of the coded stream inputted on real time are performed simultaneously.

In the data encoding/decoding apparatus 1 of FIG. 1, a clock generating unit 8 generates a system clock which should be supplied to each circuit component during operation.

The decoding of the coded stream IN inputted on real time is carried out by a decoder 16. The video data which is produced as a result of the decoding processing by the decoder 16 is stored in a video output memory 13. The audio data which is produced as a result of the decoding processing by the decoder 16 is stored in an audio output memory 15.

A video output interface (IF) 12 outputs at appropriate times to an external video output device (not shown) the video data, stored in the video output memory 13, in a predetermined format that is in conformity with the video output device. The output video data that is output by the video output IF 12 is called the video output signal.

On the other hand, an audio output interface (IF) 14 outputs at appropriate times to an external audio output device (not shown) the audio data, stored in the audio output memory 15, in a predetermined format that is conformity with the audio output device. The output audio data that is output by the audio output interface 14 is called the audio output signal.

In a video input interface 2, the video data in the form that can be encoded by an encoder 6 at the subsequent stage is generated from either the video input signal from an external device or the video data output from the video output interface 12. The video input interface 2 stores the video data in a video input memory 3.

Especially when delivering the video data from the decoder 16 to the encoder 6, the video output data of the video output interface 12 are sent to the video input interface 2 through the video output signal line 25. The video input interface 2 stores the video data in a predetermined format in the video input memory 3 at predetermined times.

On the other hand, in an audio input interface 4, the audio data in the form that can be encoded by the encoder 6 at the subsequent stage is generated from either the audio input signal from an external device or the audio output data from the audio output interface 14. The audio input interface 4 stores the audio data in an audio input memory 5.

Especially when delivering the audio data from the decoder 16 to the encoder 6, the audio output data of the audio output interface 14 are sent to the audio input interface 4 through the audio output signal line 27. The audio input interface 4 stores the audio data in a predetermined format in the audio input memory 5 at appropriate times.

In the encoder 6, the encoding processing for the video data stored in the video input memory 3 and the audio data stored in the audio input memory 5 is performed. The encoder 6 outputs the encoded stream OUT to an external device.

Generally, the phase of the system clock of the data encoding/decoding apparatus 1 which is the receiver side is not locked to the phase of the intended system clock of the transmitter side which transmits the encoded stream on real time. For this reason, in an MPEG (Moving Picture Experts Group) system, PCR (Program Clock Reference) information is added to the stream of the transmitter side. In the phase adjustment unit 7 of FIG. 1, the phase difference between the two clocks is corrected through adjustment of the system clock of the data encoding/decoding apparatus 1 on the receiver side using the PCR information.

In the composition of FIG. 1, the input stream from the decoder 16 is received at the phase adjustment unit 7 through a signal line 23. The system clock in which the phase of the system clock generated by the clock generating unit 8 is adjusted by the phase adjustment unit 7 based on the PCR information on the received input stream is supplied to the circuit components of the data encoding/decoding apparatus 1.

However, it is difficult to adjust the phase of the internally generated system clock of the data encoding/decoding apparatus 1 so as to match with the phase of the system clock of an external system in this way. There is a problem in that the scale of the entire circuit needed for the clock phase adjustment is increased.

On the other hand, there may be also a case in which the PCR information as in the above-mentioned MPEG system is not carried by the input stream transmitted on real time.

In such a case, it is difficult to precisely synchronize the system clock of the transmitter side which transmits the input stream on real time, with the system clock of the receiving side which receives the input stream. During operation over an extended period of time, the underflow condition or the overflow condition of the video output memory 13 or the audio output memory 15 may occur.

In order to avoid such conditions, there is a conventional data encoding/decoding apparatus which performs the frame synchronization processes shown in FIG. 2A and FIG. 2B. Suppose that such data encoding/decoding apparatus performing the frame synchronization processes has a circuit configuration that is similar the data encoding/decoding apparatus 1 of FIG. 1 but does not include the phase adjustment unit 7 therein.

When the video data in the video output memory 13 is likely to be in the underflow condition as shown in FIG. 2A, the frame synchronization processes are performed such that the displaying operation of a certain image frame (e.g., the “frame#3” in the example of FIG. 2A) in the video output memory 13 is performed repeatedly, which is called the repeat operation.

On the contrary, when the video data in the video output memory 13 is likely to be in the overflow condition as shown in FIG. 2B, the frame synchronization processes are performed such that a certain image frame (e.g., the “frame#2” in the example of FIG. 2B) in the video output memory 13 is wasted without displaying it, which is called the skip operation.

As described above, the conventional data encoding/decoding apparatus is devised to perform the frame synchronization processes as in FIG. 2A and FIG. 2B, in order to control the output of video data from the video output interface 12. Hence, the conventional data encoding/decoding apparatus may prevent the underflow condition or overflow condition of the video output memory 13 in advance.

Similarly, as for audio data, the conventional data encoding/decoding apparatus may prevent the underflow condition or overflow condition of the audio output memory 15 in advance by controlling the output of audio data from the audio output interface 14 through the above-described frame synchronization processes.

However, even if the conventional data encoding/decoding apparatus is devised as described above, when the video data output from the video output interface 12 is encoded, the sequence of image frames in which certain frames are skipped or repeated is included in the outgoing stream of video data. Similarly, also as for audio data, when the audio data output from the audio outputs interface 14 are encoded, abnormal sound or noise as the results of the frame synchronization processes is included in the outgoing stream of audio data.

As mentioned above, when the transcoding of the coded stream inputted on real time is carried out in the conventional data encoding/decoding apparatus 1 of FIG. 1, it is necessary to synchronize the system clock of the data encoding/decoding apparatus 1 which is the receiver side, with the intended system clock of the transmitter side which transmits the encoded stream on real time. For this purpose, by using the phase adjustment unit 7, the system clock of the data encoding/decoding apparatus 1 which is the receiver side must be corrected. Because the phase adjustment unit 7 is incorporated in the conventional data encoding/decoding apparatus 1, the scale of the circuit and the cost will be increased.

Moreover, there is a case in which the transcoding has to be carried out when the PCR information for adjusting the clock phase is not added to the incoming stream inputted on real time. In such a case, the clock phase adjustment cannot be performed based on the PCR information. To obviate the problem, the frame synchronization processes will be used.

However, the output data of the video output interface 12 and the audio output interface 14 after the frame synchronization processes are performed are encoded, and the influences of the frame synchronization (the image frames skipped or repeated, the abnormal sound, etc.) are contained in the outgoing stream OUT which is output from the encoder 6. This will cause the deterioration of the quality of the video/audio stream being reproduced.

### SUMMARY OF THE INVENTION

An object of the present invention is to provide an improved data encoding/decoding apparatus in which the above-described problems are eliminated.

Another object of the present invention is to provide a data encoding/decoding apparatus which effectively prevents the influences of the frame synchronization from being included in the outgoing stream during the processing of the coded stream inputted on real time, without using the phase adjustment unit which adjusts the phase difference of the transmitting-side clock and the receiving-side clock.

Another object of the present invention is to provide a decoding apparatus which effectively prevents the influences of the frame synchronization from being included in the outgoing stream during the processing of the coded stream inputted on real time, without using the phase adjustment unit which adjusts the phase difference of the transmitting-side clock and the receiving-side clock.

The above-mentioned objects of the present invention are achieved by a data encoding/decoding apparatus comprising: a decoder decoding a coded stream, which is formed in a first format and inputted on real time, to generate video data and audio data; a video output memory storing the video data from the decoder; an audio output memory storing the audio data from the decoder; a video input memory provided to be connected to the decoder through a first data path when transcoding of the coded stream of the first format is performed to generate a second stream formed in a second format; an audio input memory provided to be connected to the decoder through a second data path when the transcoding is performed; and an encoder encoding the video data from the video input memory and the audio data from the audio input memory to generate the second stream of the second format.

The above-mentioned objects of the present invention are achieved by a decoding apparatus for use with an external encoder connected to the decoding apparatus, the decoding apparatus comprising: a decoder decoding a coded stream, which is formed in a first format and inputted on real time, to generate video data and audio data; a video output memory storing the video data from the decoder; an audio output memory storing the audio data from the decoder; a first data path provided to deliver the video data from the decoder to the external encoder, the first data path connecting the decoder and the external encoder when the coded stream of the first format is transcoded to generate a second stream formed in a second format; and a second data path provided to deliver the audio data from the decoder to the external encoder when the transcoding is performed.

According to the data encoding/decoding apparatus of the present invention, instead of the video data supplied from the video output interface, the video data output from the decoder are stored in the video input memory so as to be delivered to the encoder, and, instead of the audio data supplied from the audio output interface, the audio data output from the decoder are stored in the audio input memory so as to be delivered to the encoder. Therefore, the influences of the control which prevents the underflow condition and overflow condition of the video output memory and the audio output memory, such as the frame synchronization influences are completely removed from the outgoing stream generated when the transcoding is performed.

Moreover, since the phase adjustment unit for adjusting the phase difference between the transmitting-side clock and the receiving-side clock is not needed, the data encoding/decoding apparatus can be configured with a small scale of the circuit.

### BRIEF DESCRIPTION OF THE DRAWINGS

Other objects, features and advantages of the present invention will be apparent from the following detailed description when read in conjunction with the accompanying drawings.

FIG. 1 is a block diagram of a conventional data encoding/decoding apparatus.

FIG. 2A and FIG. 2B are diagrams for explaining frame synchronization processes that are performed to prevent the underflow condition and the overflow condition of a video output memory respectively.

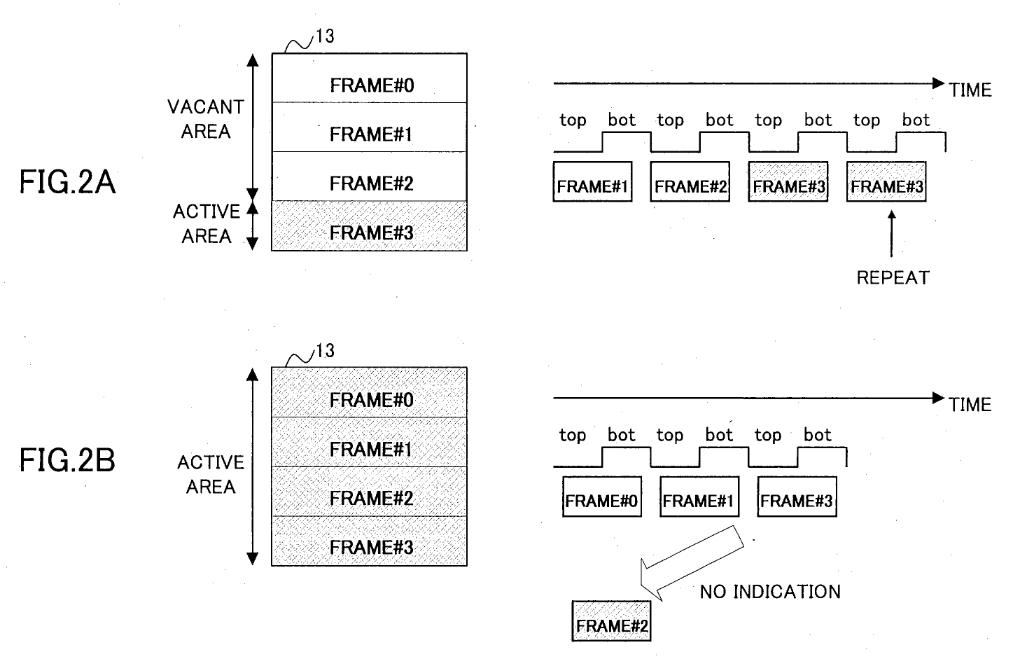

FIG. 3 is a block diagram of a data encoding/decoding apparatus according to the present invention.

FIG. 4 is a block diagram of a data encoding/decoding apparatus of the first preferred embodiment of the present invention.

FIG. 5 is a block diagram of a data encoding/decoding apparatus of the second preferred embodiment of the present invention.

FIG. 6 is a block diagram of a data encoding/decoding apparatus of the third preferred embodiment of the present invention.

FIG. 7 is a timing chart for explaining operation of the data encoding/decoding apparatus according to the present invention.

FIG. 8 is a block diagram of a decoding apparatus of the fourth preferred embodiment of the present invention.

### DETAILED DESCRIPTION OF PREFERRED EMBODIMENTS

A description will now be given of preferred embodiments of the present invention with reference to the accompanying drawings.

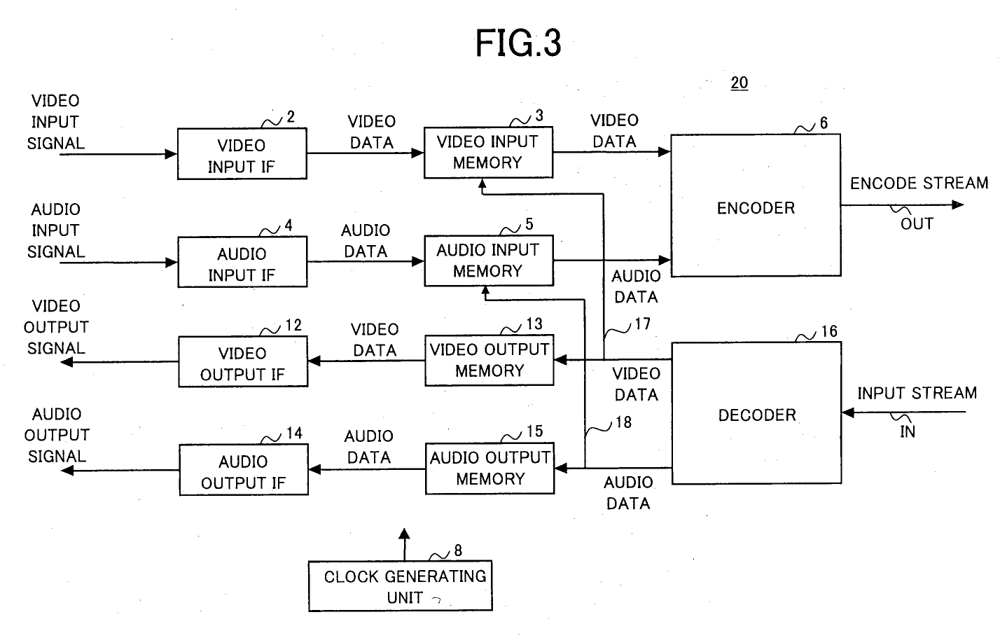

FIG. 3 shows the composition of a data encoding/decoding apparatus according to the present invention.

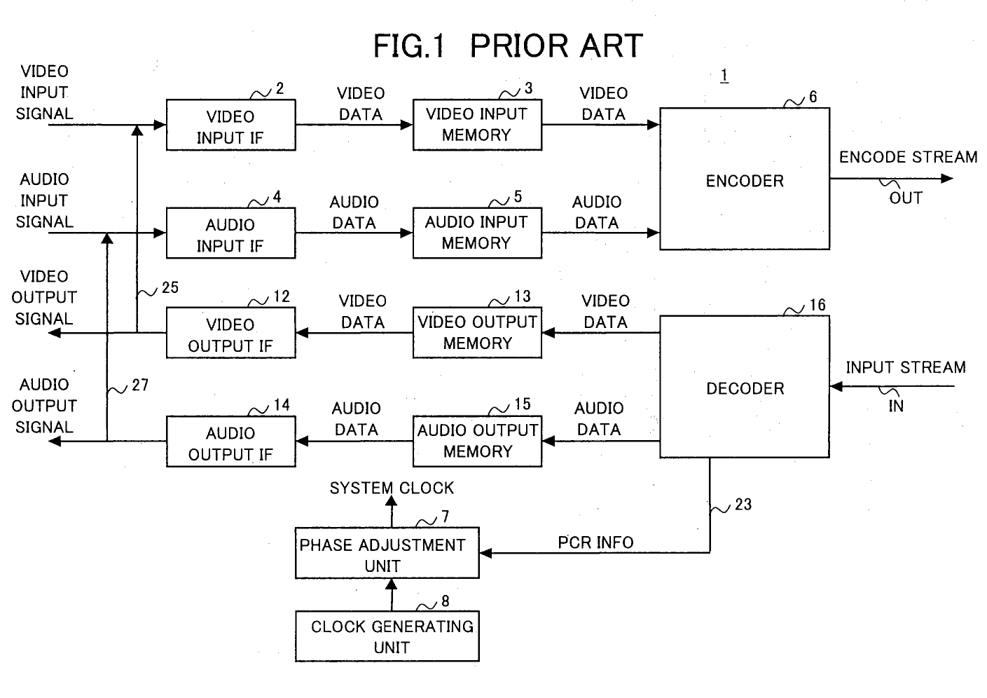

In FIG. 3, the elements that are essentially the same as corresponding elements in FIG. 1 are designated by the same reference numerals, and a description thereof ill be omitted.

As shown in FIG. 3, the data encoding/decoding apparatus 20 comprises a decoder 16, a video output memory 13, an audio output memory 15, the video input memory 3, the audio input memory 5, and the encoder 6.

In the data encoding/decoding apparatus 20 of FIG. 3, the decoder 16 performs the decoding (or transcoding) of the incoming coded stream IN which is inputted on real time. The video data that is output by the decoder 16 as a result of the decoding processing is stored in the video input memory 3 through a video data path 17. At the same time, the video data output by the decoder 16 is stored in the video output memory 13 similar to that of the conventional apparatus 1 of FIG. 1.

The audio data that is output by the decoder 16 as a result of the decoding (or transcoding) processing is stored in the audio output memory 15 similar to that of the conventional apparatus 1 of FIG. 1. At the same time, the audio data output by the decoder 16 is stored in the audio input memory 5 through an audio data path 18.

The storing operation to store the video data from the decoder 16 into the video input memory 3 and the storing operation to store the audio data from the decoder 16 into the audio input memory 5 are attained respectively by a control unit (not shown) of the data encoding/decoding apparatus 20 which performs switching control of the video data path 17 and the audio data path 18 to set both the paths from OFF state to ON state during the decoding (or transcoding) operation.

In the above composition of the data encoding/decoding apparatus 20, the video output interface 12 may be configured to output the video data, stored in the video output memory 13, at appropriate times, while preventing, in advance, the underflow condition and overflow condition of the stored video data in the video output memory 13 by using the frame synchronization processes.

Moreover, in the above composition of the data encoding/decoding apparatus 20, the audio output interface 14 may be configured to output at appropriate times the audio data stored in the audio output memory 15, in a predetermined format that is in conformity with the external audio output device, while preventing, in advance, the underflow condition and overflow condition of the audio output memory 15 by using the frame synchronization processes.

The video input interface 2 generates the video data in the digital format that can be encoded by the encoder 6 at the following stage, from the video input signal delivered from the external device (not shown). The video input interface 2 stores the resulting video data in the video input memory 3.

The audio input interface 4 generates the audio data in the digital format that can be encoded by the encoder 6 at the following stage, from the audio input signal delivered from the external device. The audio input interface 4 stores the resulting audio data in the audio input memory 5.

The encoder 6 performs the encoding (or transcoding) processing for the video data stored in the video input memory 3, and the audio data stored in the audio input memory 5. As a result of the encoding processing, the encoder 6 outputs the encoded stream OUT as the outgoing stream to a subsequent-stage device.

As described above, in the data encoding/decoding apparatus 20 of FIG. 3, instead of the video data supplied from the output of the video output interface 12, the video data output from the decoder 16 is delivered directly to the encoder 6 via the video input memory 3. Moreover, instead of the audio data supplied from the output of the audio output interface 14, the audio data output from the decoder 16 is delivered directly to the encoder 6 via the audio input memory 5.

Accordingly, it is possible that the data encoding/decoding apparatus 20 of the above described composition effectively prevent the influences of the frame synchronization (the image frames skipped or repeated, the abnormal sound, etc.) from being included in the outgoing stream of the encoder 6 during the processing (or transcoding) of the incoming coded stream by the decoder 16, while preventing the underflow condition and overflow condition of the video and audio output memories 13 and 15.

Moreover, the data encoding/decoding apparatus 20 of the above described composition does not require the phase adjustment unit which corrects completely the phase difference between the transmitting-side clock and the receiving-side clock.

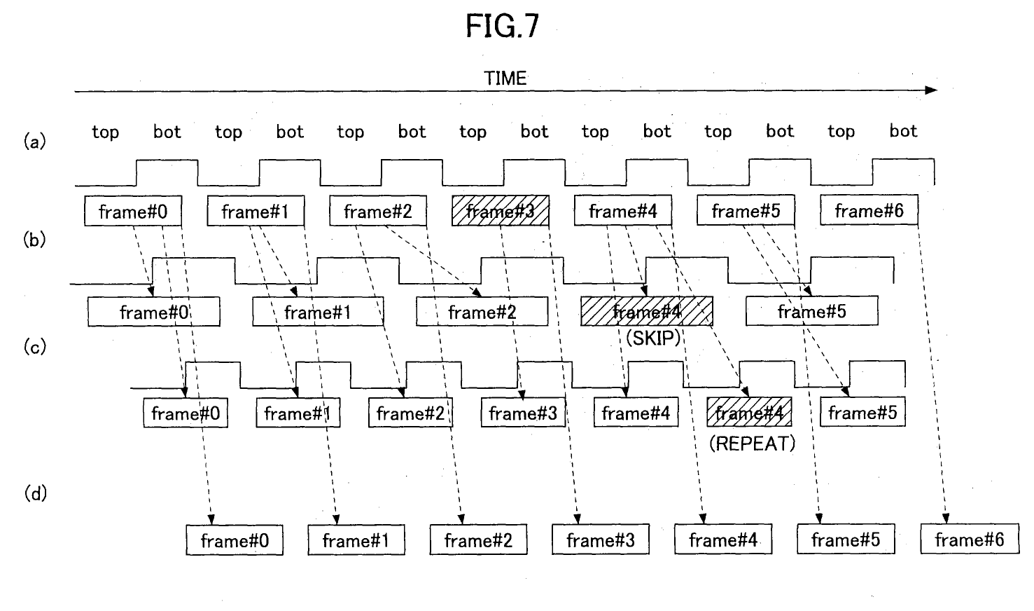

FIG. 7 is a timing chart for explaining operation of the data encoding/decoding apparatus 20 according to the present invention.

In FIG. 7, (a) indicates the clock signals of the transmitting-side device, and the incoming coded stream (frame#0, frame#1, etc.) which is inputted on real time from the transmitting-side device. In the coded stream, each frame corresponds to one of the clock signals.

(b) in FIG. 7 indicates the clock signals of the data encoding/decoding apparatus 20 which is the receiving-side device, and the stream (frame#0, frame#1, etc.) generated when the processing (or transcoding) of the incoming coded stream is performed. More specifically, a period of the clock signals of the receiving-side device indicated by (b) in FIG. 7 is larger than a period of the clock signals of the transmitting-side device indicated by (a) in FIG. 7.

For the sake of convenience of description, the time needed for the decoding processing is ignored in the example of FIG. 7.

In a case in which the clock signals of the data encoding/decoding apparatus 20 are slower than the clock signals of the incoming coded stream, it is likely to cause the overflow condition of the video data in the video output memory 13 or the audio data in the audio output memory 15 to occur.

When the video output interface 12 (or the audio output interface 14) acts to avoid the overflow condition by performing the frame synchronization processes, the skip operation is performed for some of the image frames in the video data (or the audio data). The influences of the frame synchronization will appear on the video output signal outputted from the video output interface 12, and the audio output signal outputted from the audio output interface 14.

On the other hand, (c) in FIG. 7 indicates the clock signals of the data encoding/decoding apparatus 20, and the stream (frame#0, frame#1, etc.) generated when the processing (or transcoding) of the incoming coded stream is performed. More specifically, a period of the clock signals of the receiving-side device indicated by (c) in FIG. 7 is smaller than a period of the clock signals of the transmitting-side device indicated by (a) in FIG. 7.

In a case in which the clock signals of the data encoding/decoding apparatus 20 are faster than the clock signals of the incoming coded stream, it is likely to cause the underflow condition of the video data in the video output memory 13 or the audio data in the audio output memory 15 to occur.

When the video output interface 12 (or the audio output interface 14) acts to avoid the underflow condition by performing the frame synchronization processes, the repeat operation is performed for some of the image frames in the video data (or the audio data). The influences of the frame synchronization will appear on the video output signal outputted from the video output interface 12, and the audio output signal outputted from the audio output interface 14.

Here, in the data encoding/decoding apparatus 20 of the present invention, instead of the video data supplied from the output of the video output interface 12, the video data output from the decoder 16 is delivered directly to the encoder 6 via the video input memory 3. Moreover, instead of the audio data supplied from the output of the audio output interface 14, the audio data output from the decoder 16 is delivered directly to the encoder 6 via the audio input memory 5.

Therefore, as indicated by (d) in FIG. 7, the outgoing stream of the encoder 6 of the data encoding/decoding apparatus 20, when the processing (transcoding) of the incoming encoded stream is performed by the decoder 16, does not contain any influence of the frame synchronization (the image frames skipped or repeated, the abnormal sound, etc.).

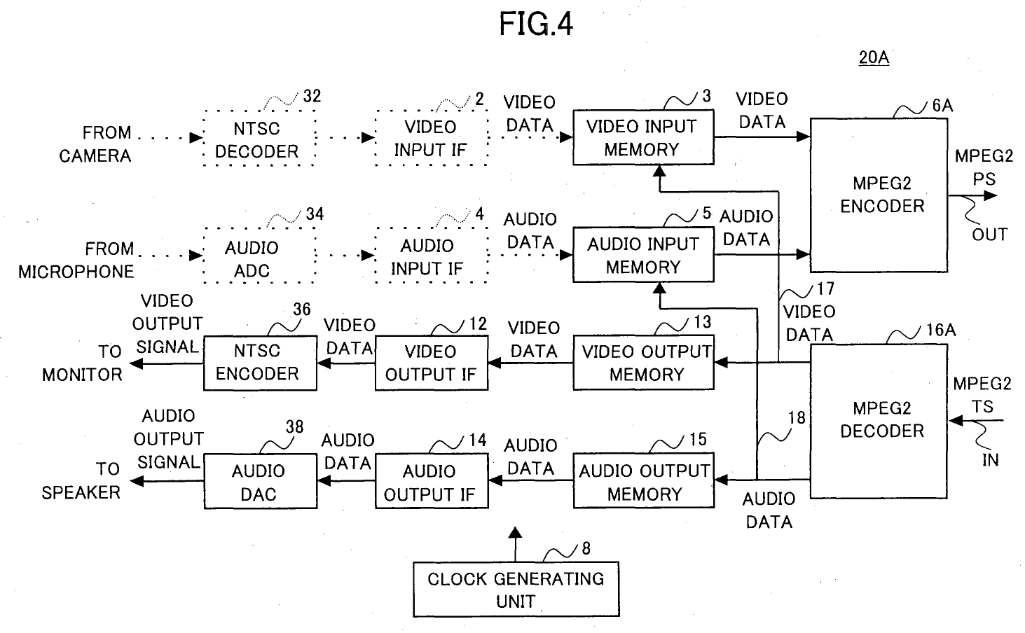

FIG. 4 shows the composition of a data encoding/decoding apparatus 20A of the first preferred embodiment of the present invention.

With reference to FIG. 4, a description will now be given of operation of the data encoding/decoding apparatus 20A of the present embodiment by which the incoming MPEG2 TS (transport stream) which is inputted on real time is transcoded to the MPEG2 PS (program stream).

The MPEG2 decoder 16A of FIG. 4 performs the decoding processing of the incoming MPEG2 TS which is inputted on real time, and the resulting video data is stored in the video output memory 13. At the same time, the MPEG2 decoder 16A stores the resulting video data also in the video input memory 3 through the video data path 17.

On the other hand, the MPEG2 decoder 16A performs the decoding processing of the incoming MPEG2 TS, and the resulting audio data is stored in the audio output memory 15. At the same time, the MPEG2 decoder 16A stores the resulting audio data also in the audio input memory 5 through the audio data path 18.

The storing operation to store the video data from the decoder 16A into the video input memory 3 and the storing operation to store the audio data from the decoder 16A into the audio input memory 5 are attained respectively by a control unit (not shown) of the data encoding/decoding apparatus 20A which performs switching control of the video data path 17 and the audio data path 18 to set both the paths from OFF state to ON state during the decoding (or transcoding) operation.

At the video output interface 12, the video data stored in the video output memory 13 is outputted to an NTSC (National Television System Committee) encoder 36 at appropriate times, while preventing, in advance, the underflow condition and overflow condition of the video output memory 13 by using the frame synchronization processes.

At the audio output interface 14, the audio data stored in the audio output memory 15 is outputted to an audio DAC (digital-to-analog converter) 38 at appropriate times, while preventing, in advance, the underflow condition and overflow condition of the audio output memory 15 by using the frame synchronization processes.

Although the video input interface 2 has the function to store in the video input memory 3 the video signal (video signal inputted from the external camera etc.) from an NTSC decoder 32, it does not work during the transcoding operation of the data encoding/decoding apparatus 20A in the present embodiment.

Similarly, although the audio input interface 4 has the function to store in the audio input memory 5 the audio signal (audio signal inputted from the external microphone etc.) from an audio ADC (analog-to-digital converter) 34, it does not function during the transcoding operation of the data encoding/decoding apparatus 20A in the present embodiment.

When the video data or the audio data produced by the MPEG2 decoder 16A as a result of the decoding processing is detected in the video input memory 3 or the audio input memory 5, the MPEG2 encoder 6A encodes such data to generate the MPEG2 PS stream so that the MPEG2 PS stream is outputted as the outgoing stream OUT.

Hence, the MPEG2 encoder 6A can generate the outgoing stream OUT without regard to the phase difference between the transmitting-side clock signal of the incoming stream IN and the receiving-side clock of the data encoding/decoding apparatus 20A.

In the present embodiment, the MPEG2 encoder 6A is capable of encoding data on real time. In the data encoding/decoding apparatus 20A of the present embodiment, the encoded MPEG2 PS stream OUT is not produced from the output data of the video output interface 12 or the audio output interface 14, and the outgoing stream OUT does not contain any influence of the frame synchronization (the image frames skipped or repeated, the abnormal sound, etc.) even if the frame synchronization processes are performed.

The clock generating unit 8 generates the clock signal of 27 MHz as in the MPEG standard during operation. However, it is not necessary for the data encoding/decoding apparatus 20A of the present embodiment to correct the phase difference between the two clocks through adjustment of the system clock of the data encoding/decoding apparatus 20A with the system clock of the incoming MPEG2 TS stream of the transmitting side device.

In the above-described embodiment of FIG. 4, the transcoding from the incoming MPEG2 TS stream to the outgoing MPEG2 PS stream is carried out by using the MPEG2 encoder 6A and decoder 16A in the data encoding/decoding apparatus 20A. However, the data encoding/decoding apparatus of the present invention is not limited this embodiment. For example, the transcoding from the incoming MPEG2 TS stream to the MPEG4 stream may be carried out by using the MPEG4 encoder, instead of the MPEG2 encoder 6A of FIG. 4.

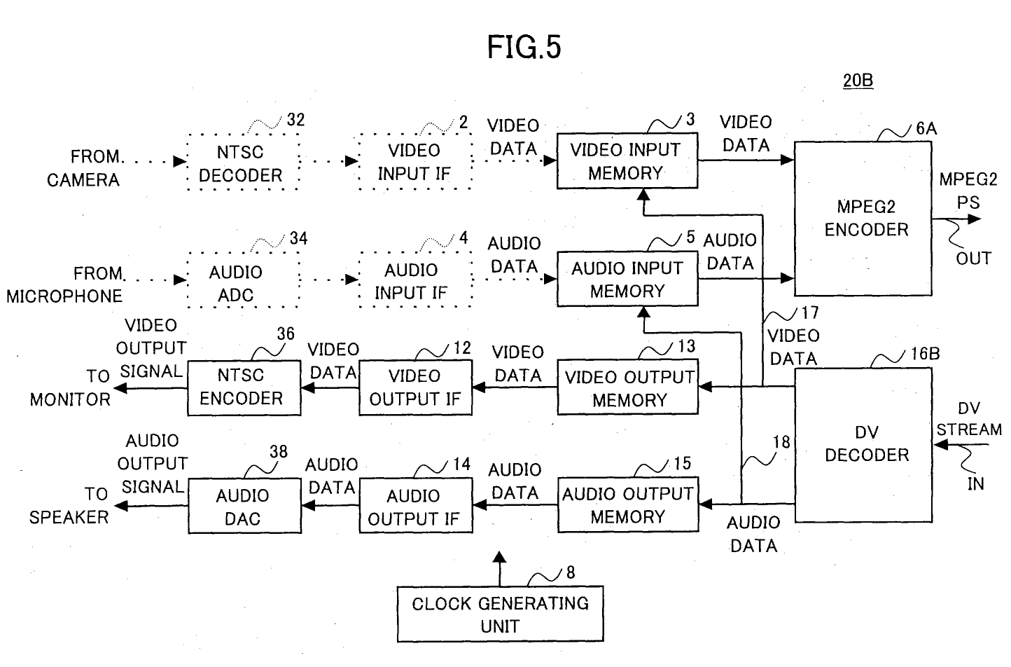

FIG. 5 shows the composition of a data encoding/decoding apparatus 20B of the second preferred embodiment of the present invention.

With reference to FIG. 5, a description will be given of operation of the data encoding/decoding apparatus 20B of the present embodiment by which the incoming DV (digital video) stream carried on the IEEE1394 bus inputted on real time is transcoded to the MPEG2 PS (program stream).

The DV decoder 16B of FIG. 5 performs the decoding processing of the incoming DV stream inputted on real time, and the resulting video data is stored in the video output memory 13. At the same time, the DV decoder 16B stores the resulting video data also in the video input memory 3 through the video data path 17.

On the other hand, the DV decoder 16B performs the decoding processing of the DV stream, and the resulting audio data is stored in the audio output memory 15. At the same time, the DV decoder 16B stores the resulting audio data also in the audio input memory 5 through the audio data path 18.

The storing operation to store the video data from the DV decoder 16B into the video input memory 3 and the storing operation to store the audio data from the DV decoder 16B into the audio input memory 5 are attained respectively by a control unit (not shown) of the data encoding/decoding apparatus 20B, which performs switching control of the video data path 17 and the audio data path 18 to set both paths from OFF state to ON state during the decoding (or transcoding) operation.

At the video output interface 12, the video data stored in the video output memory 13 is outputted to the NTSC encoder 36 at appropriate times, while preventing, in advance, the underflow condition and overflow condition of the video output memory 13 by using the frame synchronization processes.

At the audio output interface 14, the audio data stored in the audio output memory 15 is outputted to the audio DAC 38 at appropriate times, while preventing, in advance, the underflow condition and overflow condition of the audio output memory 15 by using the frame synchronization processes.

Although the video input interface 2 has the function to store the video signal from the NTSC decoder 32 in the video input memory 3, it does not function during the transcoding operation of the present embodiment.

Similarly, although the audio input interface 4 has the function to store the audio signal from the audio ADC 34 in the audio input memory 5, it does not function during the transcoding operation of the present embodiment.

When the video data or the audio data produced by DV decoder 16B as a result of the decoding processing is detected in the video input memory 3 or the audio input memory 5, the MPEG2 encoder 6A encodes such data to generate the MPEG2 PS stream, so that the MPEG2 PS stream is outputted as the outgoing stream OUT.

Hence, the MPEG2 encoder 6A can generate the outgoing stream OUT without regard to the phase difference between the transmitting-side clock signal of the incoming stream IN and the receiving-side clock signal of the data encoding/decoding apparatus. 20B.

In the present embodiment, the MPEG2 encoder 6A is capable of encoding data on real time. In the data encoding/decoding apparatus 20B of the present embodiment, the encoded MPEG2 PS stream OUT is not produced from the output data of the video output interface 12 or the audio output interface 14, and the outgoing stream OUT does not contain any influence of the frame synchronization (the image frames repeated or skipped, the abnormal sound, etc.) even if the frame synchronization processes are performed.

The clock generating unit 8 generates the clock signal of 27 MHz as in the DV specification during operation. However, it is not necessary for the data encoding/decoding apparatus 20B of the present embodiment to correct the phase difference between the two clocks through adjustment of the system clock of the data encoding/decoding apparatus 20B with the system clock of the incoming DV stream of the transmitting side device.

In the above-described embodiment of FIG. 5, the transcoding from the incoming DV stream to the outgoing MPEG2 PS stream is carried out by using the DV decoder 16B and the MPEG2 encoder 6A in the data encoding/decoding apparatus 20B. However, the data encoding/decoding apparatus of the present invention is not limited to this embodiment. For example, the transcoding from the DV stream to the MPEG4 stream may be carried out by using the MPEG4 encoder instead of the MPEG2 encoder 6A of FIG. 5.

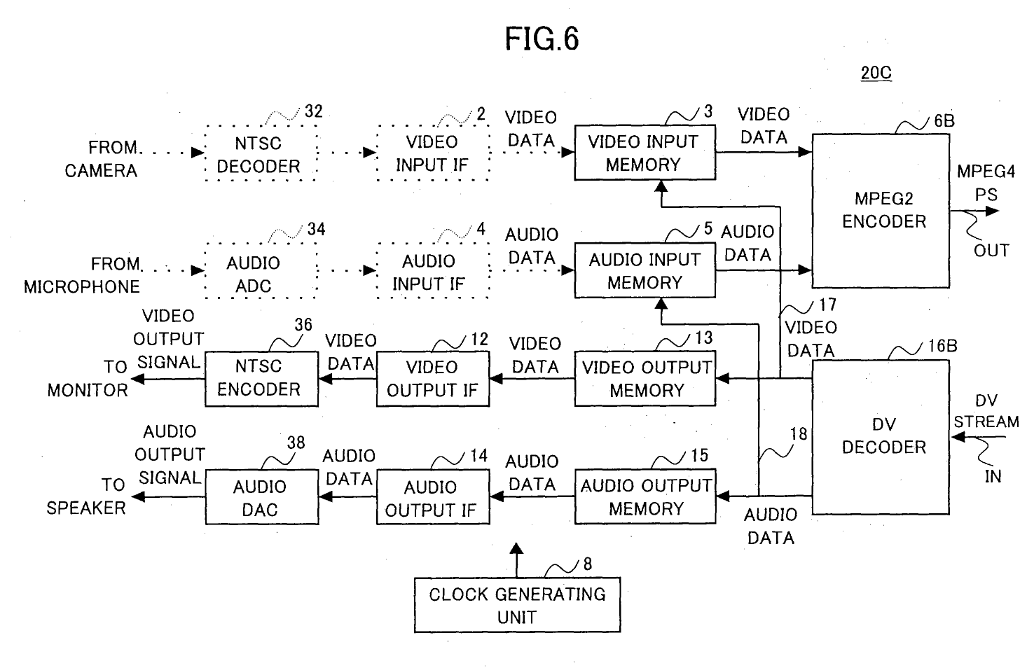

FIG. 6 shows the composition of a data encoding/decoding apparatus 20C of the third preferred embodiment of the present invention.

With reference to FIG. 6, a description will be given of operation of the data encoding/decoding apparatus 20C of the present embodiment by which the incoming DV stream carried on the IEEE1394 bus which is inputted on real time is transcoded to the MPEG4 PS.

The DV decoder 16B of FIG. 6 performs the decoding processing of the incoming DV stream which is inputted on real time, and the resulting video data is stored in the video output memory 13. At the same time, the DV decoder 16B stores the resulting video data also in the video input memory 3 through the video data path 17.

On the other hand, the DV decoder 16B performs the decoding processing of the incoming DV stream, and the resulting audio data is stored in the audio output memory 15. At the same time, the DV decoder 16B stores the resulting audio data also in the audio input memory 5 through the audio data path 18.

The storing operation to store the video data from the DV decoder 16B into the video input memory 3 and the storing operation to store the audio data from the DV decoder 16B into the audio input memory 5 are attained respectively by a control unit (not shown) of the data encoding/decoding apparatus 20C, which performs switching control of the video data path 17 and the audio data path 18 to set both paths from OFF state to ON state during the decoding (or transcoding) operation.

At the video output interface 12, the video data stored in the video output memory 13 is outputted to the NTSC encoder 36 at appropriate times, while preventing, in advance, the underflow condition and overflow condition of the video output memory 13 by using the frame synchronization processes.

At the audio output interface 14, the audio data stored in the audio output memory 15 is outputted to the audio DAC 38 at appropriate times, while preventing, in advance, the underflow condition and overflow condition of the audio output memory 15 by using the frame synchronization processes.

Although the video input interface 2 has the function to store the video signal from the NTSC decoder 32 in the video input memory 3, it does not function during the transcoding operation of the data encoding/decoding apparatus 20C in the present embodiment.

Similarly, although the audio input interface 4 has the function to store the audio signal from the audio ADC 34 in the audio input memory 5, it does not function during the transcoding operation of the data encoding/decoding apparatus 20C in the present embodiment.

When the video data or the audio data produced by the DV decoder 16B as a result of the decoding processing is detected in the video input memory 3 or the audio input memory 5, the MPEG4 encoder 6B encodes such data to generate the MPEG4 PS stream, so that the MPEG4 PS stream is outputted as the outgoing stream OUT.

Hence, the MPEG4 encoder 6B can generate the outgoing stream OUT without regard to the phase difference between the transmitting-side clock signal of the incoming stream IN and the receiving-side clock signal of the data encoding/decoding apparatus 20C.

In the present embodiment, the MPEG4 encoder 6B is capable of encoding data on real time. In the data encoding/decoding apparatus 20C of the present embodiment, the encoded MPEG4 PS stream OUT is not produced from the output data of the video output interface 12 or the audio output interface 14, and the outgoing stream OUT does not contain any influence of the frame synchronization (the image frames repeated or skipped, the abnormal sound, etc.) even if the frame synchronization processes are performed.

The clock generating unit 8 generates the clock signal of 27 MHz as in the DV specification during operation. However, it is not necessary for the data encoding/decoding apparatus 20C of the present embodiment to correct the phase difference between the two clocks through adjustment of the system clock of the data encoding/decoding apparatus 20C of the present embodiment with the system clock of the incoming DV stream of the transmitting-side device.

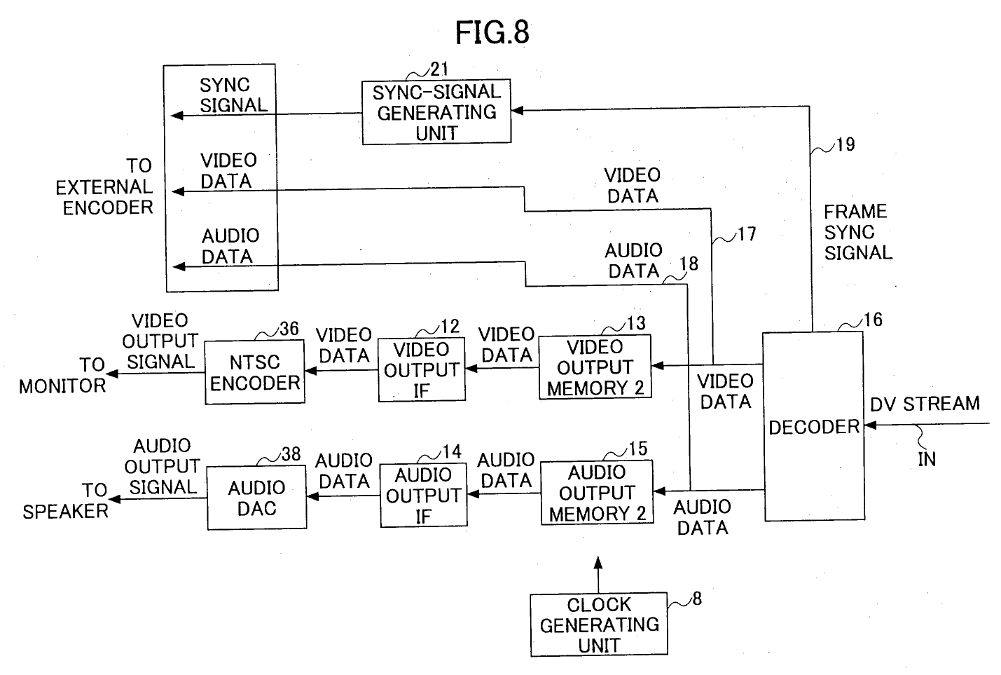

FIG. 8 shows the composition of a decoding apparatus of the fourth preferred embodiment of the present invention.

The decoding apparatus of the present embodiment is provided for use with an external encoder connected to the decoding apparatus. With reference to FIG. 8, a description will be given of the transcoding operation of the decoding apparatus of the present embodiment as in the preferred embodiments of FIG. 4 through FIG. 6.

In the present embodiment, the transcoding of the DV stream inputted on real time from the IEEE1394 bus of an external device to generate the outgoing stream is carries out by using the decoding apparatus and the external encoder. However, the decoding apparatus of the present invention is not limited to this embodiment. For example, the transcoding of the MPEG2 TS stream or other input streams as in the previous embodiments may be carried out by the decoding apparatus of the present invention.

In a case of the DVCR format, the time stamp for frame synchronization is included in the header portion of one frame. Hence, by using the time stamp of the incoming DV stream, it is possible to generate the frame sync signal which is precisely synchronized with the frame of the incoming coded stream IN.

In the decoding apparatus of FIG. 8, a sync signal generating unit 21 receives the input DV stream from the decoder 16 through a frame sync signal line 19.

In the sync signal generating unit 21, based on the frame synchronization information (time stamp) of the received input DV stream, the frame sync signal is generated, and the resulting sync signal is outputted to the external encoder (not shown).

Neither the video input memory 3 nor the audio input memory 5 is provided in the decoding apparatus of FIG. 8. The video data produced by the decoder 16 as a result of the decoding processing at the time of transcoding operation is stored in the video output memory 13. At the same time, the video data is outputted to the external encoder through the video data path 17. On the other hand, the audio data produced by the decoder 16 as a result of the decoding processing is stored in the audio output memory 15. At the same time, the audio data is outputted to the external encoder through the audio data path 18.

The sync signal, the video data and the audio data are simultaneously outputted to the external encoder in the case of transcoding operation.

The output operation to output the video data from the decoder 16 to the external encoder and the output operation to output the audio data from the decoder 16 to the external encoder are attained respectively by the control unit (not shown) of the decoding apparatus which performs switching control of the video data path 17 and the audio data path 18 to set both the paths from OFF state to ON state during the decoding (or transcoding) operation.

At the video output interface 12, the video data stored in the video output memory 13 is outputted to the NTSC encoder 36 at appropriate times, while preventing, in advance, the underflow condition and overflow condition of the video output memory 13 by using the frame synchronization processes.

At the audio output interface 14, the audio data stored in the audio output memory 15 is outputted to the audio DAC 38 at appropriate times, while preventing, in advance, the underflow condition and overflow condition of the audio output memory 15 by using the frame synchronization processes.

On the other hand, in the external encoder, when the video data or the audio data produced by the decoder 16 as a result of the decoding processing is detected in a video input memory or an audio input memory of the external encoder according to the sync signal from the sync signal generating unit 21, the external encoder encodes such data to generate the corresponding stream (for example, MPEG2 PS stream), so that the encoded stream is outputted as the outgoing stream.

In the decoding apparatus of the present embodiment, the outgoing stream is not produced by the external encoder from the output data of the video output interface 12 or the audio output interface 14, and it does not contain any influence of the frame synchronization (the image frames repeated or skipped, the abnormal sound, etc.) even if the frame synchronization processes are performed.

The clock generating unit 8 generates the clock signal of 27 MHz as in the DV specification. However, it is not necessary for the decoding apparatus of the present embodiment to correct the phase difference between the two clocks through adjustment of the system clock of the decoding apparatus with the system clock of the incoming DV stream of the transmitting-side device.

As explained above, according to the data encoding/decoding apparatus of the present invention, the quality of the outgoing stream generated when the processing (transcoding) of the incoming coded stream is performed is not deteriorated since no influences (the image frames skipped or repeated, the abnormal sound, etc.) of the frame synchronization are included in the outgoing stream.

Moreover, since the phase adjustment unit which corrects completely the phase difference between the transmitting-side clock and the receiving-side clock is not needed according to the data encoding/decoding apparatus of the above-described embodiments, the data encoding/decoding apparatus can be configured with a small-scale circuit configuration and low cost.

Therefore, the data encoding/decoding apparatus of the above-described embodiments is effective in contributing to quality improvement of the reconstructed stream and manufacture of the data encoding/decoding apparatus with low cost.

The present invention is not limited to the above-described embodiments, and variations and modifications may be made without departing from the scope of the present invention.

What is claimed is:

1. A data encoding/decoding apparatus comprising:
a decoder decoding a coded stream, which is formed in a first format and inputted on real time, to generate video data and audio data;
a video output memory storing the video data from the decoder;
an audio output memory storing the audio data from the decoder;
a video input memory provided to be connected to the decoder through a first data path when the coded stream of the first format is transcoded to generate a second stream formed in a second format;
an audio input memory provided to be connected to the decoder through a second data path when the transcoding is performed; and
an encoder encoding the video data from the video input memory and the audio data from the audio input memory to generate the second stream of the second format.

2. The data encoding/decoding apparatus of claim 1 wherein, when the transcoding is performed, the first data path and the second data path are set from OFF state to ON state, so that the video data output from the decoder is stored in the video input memory through the first data path and the audio data output from the decoder is stored in the audio input memory through the second data path.

3. The data encoding/decoding apparatus of claim 1 further comprising:
a video output interface outputting the video data stored in the video output memory to an external device in a predetermined format at predetermined times; and
an audio output interface outputting the audio data stored in the audio output memory to an exterior device in a predetermined format at predetermined times.

4. The data encoding/decoding apparatus of claim 1 further comprising:
a video input interface storing in the video input memory video data which is inputted from an external device at predetermined times; and
an audio input interface storing in the audio input memory audio data which is inputted from an external device at predetermined times.

5. The data encoding/decoding apparatus of claim 1 further comprising a clock generating unit generating a clock signal for circuit components of the data encoding/decoding apparatus wherein the clock signal from the clock generating unit is supplies to each circuit component without adjusting a phase of the clock signal based on clock reference information of the coded stream inputted on real time.

6. A decoding apparatus for use with an external encoder connected to the decoding apparatus, comprising:
a decoder decoding a coded stream, which is formed in a first format and inputted on real time, to generate video data and audio data;
a video output memory storing the video data from the decoder;
an audio output memory storing the audio data from the decoder;
a first data path provided to deliver the video data from the decoder to the external encoder, the first data path connecting the decoder and the external encoder when the coded stream of the first format is transcoded to generate a second stream formed in a second format; and
a second data path provided to deliver the audio data from the decoder to the external encoder when the transcoding is performed.

7. The decoding apparatus of claim 6 wherein, when the transcoding is performed, the first data path and the second data path are set from OFF state to ON state, so that the video data output from the decoder is delivered to the external encoder through the first data path and the audio data output from the decoder is delivered to the external encoder through the second data path.

8. The data encoding/decoding apparatus of claim 1 wherein the coded stream of the first format is at least one of a MPEG2 transport stream and a digital video stream.

9. The data encoding/decoding apparatus of claim 1 wherein the second stream of the second format is at least one of a MPEG2 program stream and a MPEG4 program stream.

10. The decoding apparatus of claim 6 further comprising a clock generating unit generating a clock signal for circuit components of the decoding apparatus wherein the clock signal from the clock generating unit is supplies to each circuit component without adjusting a phase of the clock signal based on clock reference information of the coded stream inputted on real time.
